(19) United States
(12) Patent Application Publication
(10) Pub. No.: US 2005/0236832 A1
(43) Pub. Date: Oct. 27, 2005

(54) Vehicle inventory sticker form

(75) Inventors: Scott D. Best, Troy, MI (US); James F. Turner, Farmington Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Saxon, Inc.

(21) Appl. No.: 11/112,346

(22) Filed: Apr. 22, 2005

Related U.S. Application Data
(60) Provisional application No. 60/564,330, filed on Apr. 22, 2004.

(51) Int. Cl. G09C 3/00

(52) U.S. Cl. 283/74

(57) ABSTRACT

A card assembly (20) having multiple layers for matching an article to a vehicle. The card assembly (20) includes a liner (28) having a first adhesive (36) and a first layer (40) along with a second adhesive (38) and a second layer (42). A scoreline (26, 50) extends through the first layer (40), first adhesive (36), and liner (28) to define a tag portion (24, 52) of the card assembly. The tag portion (24, 52) may be removed from the second adhesive (38) to expose a portion of the second adhesive (38), which defines an attachment area (48, 54) of a card portion (22). The card portion (22) may be adhered to a vehicle surface, such as the interior of a window, by the attachment area (48, 54). The removed tag portion (24, 52) may be attached to an article, such as a key set, for matching the article to the vehicle.

### CROSS REFERENCE TO RELATED APPLICATION

This application claims the benefit of provisional application Ser. No. 60/564,330 filed on Apr. 22, 2004.

### BACKGROUND OF THE INVENTION

1. Field of the Invention

The subject invention relates to a business form, and more specifically to a card assembly for identifying a vehicle and matching a tag for identifying an article such as a key set to the vehicle.

2. Description of the Prior Art

A business form for identifying a vehicle and matching key set is well known. It is common during the servicing of a car that a tag number is attached to the rear view mirror and the associated tag number is attached to the key set. One such example of this is U.S. Pat. No. D493,840 to the same assignee as this application.

Additional requirements and demands and different expectations from the customer resulted in a form that would be durable enough to stay on the vehicle and a key tag for identifying inventory. An example of a business form that utilizes adhesives to secure a card in a vehicle, such as the inside window is shown in U.S. Pat. No. 6,352,608. The '608 patent discloses a business form with a separately attached key tag assembly for identifying an article, i.e., key set, to the matching vehicle. However, the key tag assembly must be separated from the vehicle card and the card requires additional removal of sections to expose an adhesive. In order for the key tag to have an ideal thickness and durability, the key tag requires additional folding for attaching to a key ring.

Accordingly, it would be advantageous to develop a card assembly that can be quickly marked and attached or adhered to an article such as a key set and a vehicle for matching the article to the vehicle. In addition, the card assembly, having a tag portion, should be durable enough to withstand extended use when attached to a key set without any additional assembly, i.e., peeling, folding and pressing, or discarding additional portions.

### SUMMARY OF THE INVENTION AND ADVANTAGES

A card assembly for matching a vehicle to a key set comprising of a liner having a first surface and a second surface each of the surfaces extending to a peripheral edge. A first adhesive is disposed on said first surface of said liner and a first layer is adhered to the liner by the first adhesive. A second adhesive is disposed on the second surface and a second layer is adhered to the liner by the second adhesive. A character is on a card portion of the card assembly and a matching character is on a tag portion of the card assembly. The card assembly includes a scoreline extending through the first layer, the first adhesive and the liner to define the tag portion. The first layer and the liner of the tag portion can be removed from the second adhesive in unison for attachment to the article such as a key set. The removal of the tag portion exposes a portion of the second adhesive and defines an attachment area that may adhere the card portion to the vehicle.

The subject invention also provides a method of matching a vehicle to a key set using a card assembly comprising a first adhesive disposed between a liner and a first layer and a second adhesive disposed between a second layer and the liner. A scoreline defines a tag portion and a card portion with matching characters on the card portion and the tag portion. The method comprises the steps of removing the tag portion to expose the portion of the second adhesive, attaching the tag portion to the key set, and adhering the exposed portion of the second adhesive to the vehicle.

Accordingly, the subject invention simplifies the card assembly by requiring no additional folding or discarding of additional portions in order to expose the adhesive of the card portion. Therefore, the subject invention requires no additional assembly time or discarded waste from the card assembly for adhering the card portion to the vehicle and attaching a tag portion to a matching article, such as a key set.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a planar view of a card assembly in accordance with the subject invention;

FIG. 2 is a fragmented cross-sectional view taken along line 2-2 of FIG. 1;

FIG. 3 is a fragmented exploded cross-sectional view illustrating multiple layers of the card assembly;

FIG. 4 is a planar view of the card assembly illustrating a partial removal of the tag portions;

FIG. 5 is a planar view of the card assembly with the tag portions completely removed to expose attachment areas;

FIG. 6 is a planar view of the tag portion of the card assembly;

FIG. 7 is a planar view of an alternative embodiment of the card assembly illustrating a partial removal of the tag portions;

FIG. 8 is a planar view of the card portion of the alternative embodiment with the tag portions completely removed; and

FIG. 9 is a planar view of the tag portion of the alternative embodiment.

### DETAILED DESCRIPTION OF THE INVENTION

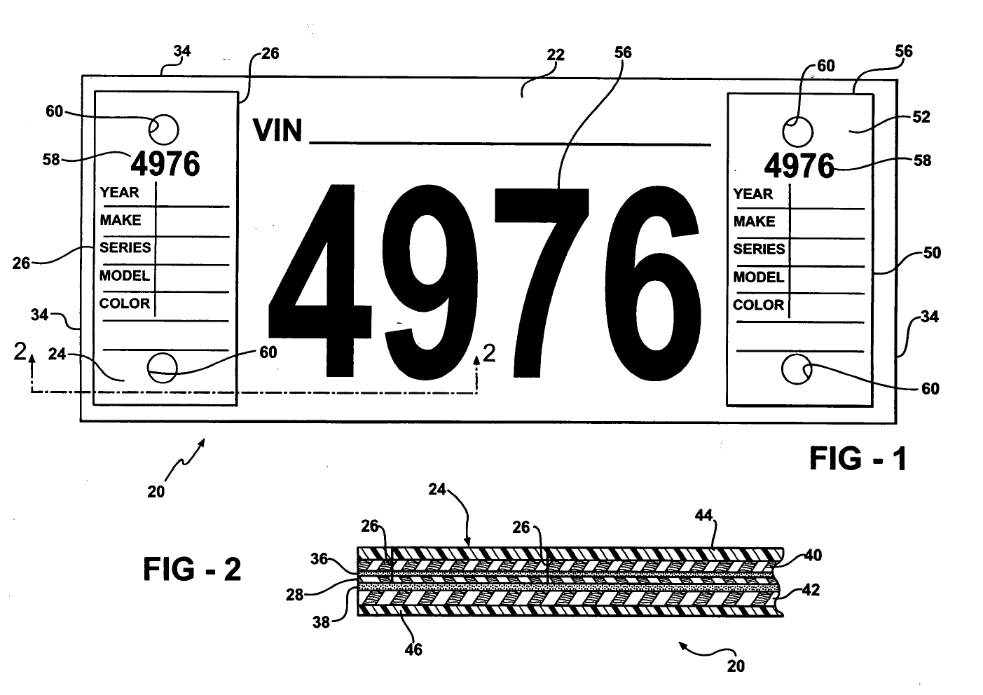

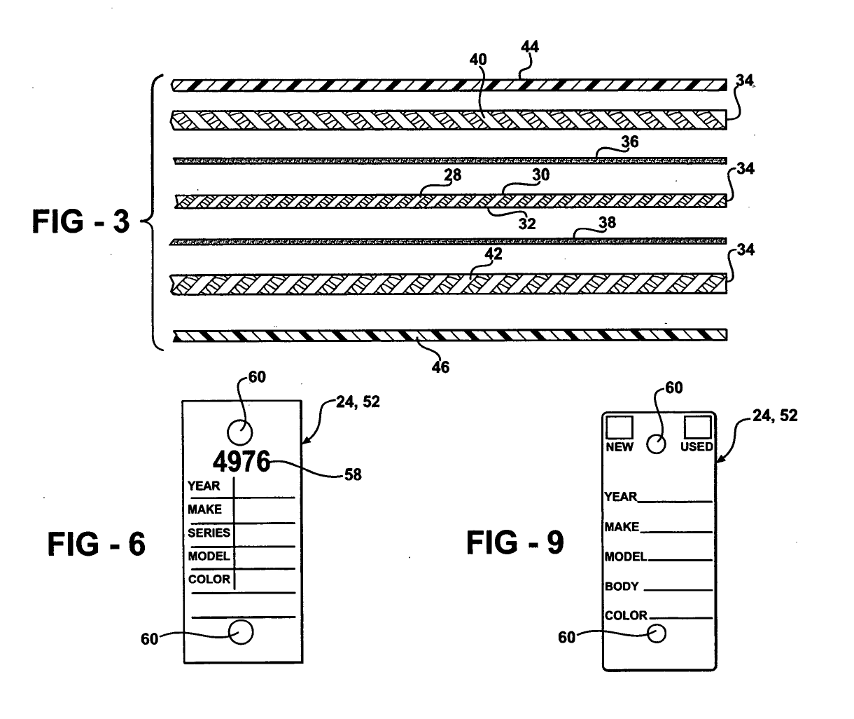

Referring to the Figures, wherein like numerals indicate corresponding parts throughout the several views, a card assembly 20 for matching a vehicle to a key set is generally shown in FIG. 1. The card assembly 20 includes a card portion 22 and a tag portion 24 for matching an article, such as a key set, to a vehicle. As shown in FIGS. 2 and 3, the card assembly 20 is a multiple layered assembly with a scoreline 26 that defines the tag portion 24.

The card assembly 20 has a liner 28 with a first surface 30 and a second surface 32 each extending to a peripheral edge 34. The liner 28 is the primary or center layer with a first adhesive 36 disposed on the first surface 30, and a second adhesive 38 disposed on the second surface 32. The card assembly 20 further includes a first layer 40 that is adhered by the first adhesive 36 to the first surface 30 of the liner 28, and a second layer 42 that is adhered by the second adhesive 38 to the second surface 32 of the liner 28. The first and second layers 40, 42 can be of various materials, for example a card stock material as known in the art. In addition, the first and second layers 40, 42 can include various material alternatives such as plastic materials depending on the customers intended use and design of the card assembly 20. Basically, the card assembly 20 can be adapted for various uses and durability depending on the needs and demands of the customer. Finally, the optional layers, especially if formed of the card stock, can include a top laminate 44 disposed on the first layer 40 and a bottom laminate 46 disposed on the second layer 42. The laminates 44, 46 are transparent layers that provide weather protection to the card stock as well as additional durability of the card assembly 20. Preferably, a ballpoint or a felt tip pen can write on plastic materials or the laminates 44, 46 of the first and second layers 40, 42. The material properties of the plastic first and second layers 40, 42 and the laminates 44, 46 are such that the ink does not smear or rub off during normal use of the card assembly 20.

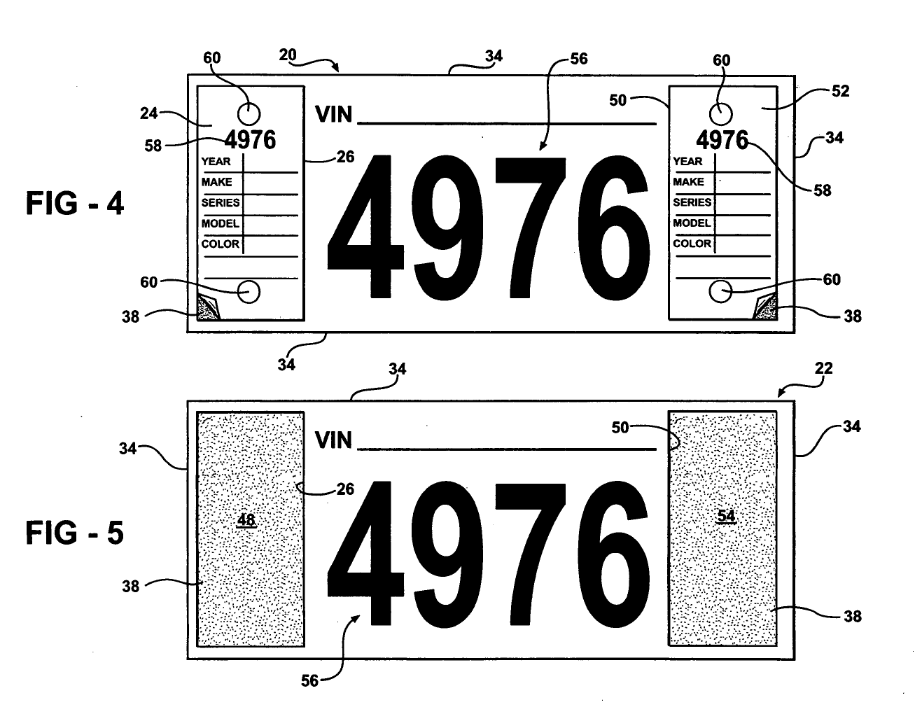

The card assembly 20 includes the scoreline 26 extending through a portion of the first layer 40, the first adhesive 36, and the liner 28 to define the tag portion 24. As shown in FIGS. 4 and 5, the first layer 40 and the liner 28 of the tag portion 24 may be removed in unison from the second adhesive 38 to expose a portion of the second adhesive 38. The exposed portion of the second adhesive 38 defines an attachment area 48 of the card portion 22. The tag portion 24, once removed from the card assembly 20 (see FIG. 6), may be attached to the key set. The exposed portion of the second adhesive 38 allows the card portion 22 to be adhered to the vehicle. The tag portion 24 includes a portion at the first layer 40, first adhesive 36, and the liner 28 to provide a durable tag portion 24 without any additional folding or assembly after the removal from the card assembly 20. This allows the user to quickly tag both a vehicle and key set without complicated assembly. The tag portion 24 is designed to be tear resistant for use on a key set, and the material properties of the first layer 40 and the liner 28 are such to accomplish the durability of the tag portion 24.

As shown in FIGS. 1, 4 and 5, the card assembly 20 includes a second scoreline 50 extending through a second portion of the first layer 40, the first adhesive 36, and the liner 28 to define a second tag portion 52. As with tag portion 24, the second tag portion 52 can be used to identify and match articles such as a key set or remote device, i.e. keyless entry devices, to a vehicle. The second tag portion 52 includes the first layer 40, the first adhesive 36, and the liner 28 which may be removed from the second adhesive 38 of the card assembly 20. The second tag portion 52 exposes a second portion of the second adhesive 38 which further defines a second attachment area 54 of the card portion 22

As shown in FIGS. 4 and 5, the liner 28, adhesives 36, 38, and layers 40, 42 of the card portion 22 extend to the peripheral edge 34. The scorelines 26, 50 are preferably completely disposed within the peripheral edge 34 and therefore do not intersect the edge 34. The tag portions 24 and the attachment areas 48 are also completely disposed within the peripheral edge 34. As seen in FIGS. 4 and 5, the tag portions 24 and the attachment areas 48 are spaced a distance inward from the top, bottom, and sides of the card portion 22 and do not intersect the peripheral edge 34.

The identification and matching of the card portion 22 to the tag portion 24 requires that a character 56 be disposed on the card portion 22 and a matching character 58 be further included on the tag portions 24. The character 56 and the matching character 58 are typically a numeral sequence as seen in the preferred embodiment in FIGS. 1-6. The preferred embodiment allows the user to further include additional identifying vehicle information on the tag portion 24, such as the year, make, model and color, if desired.

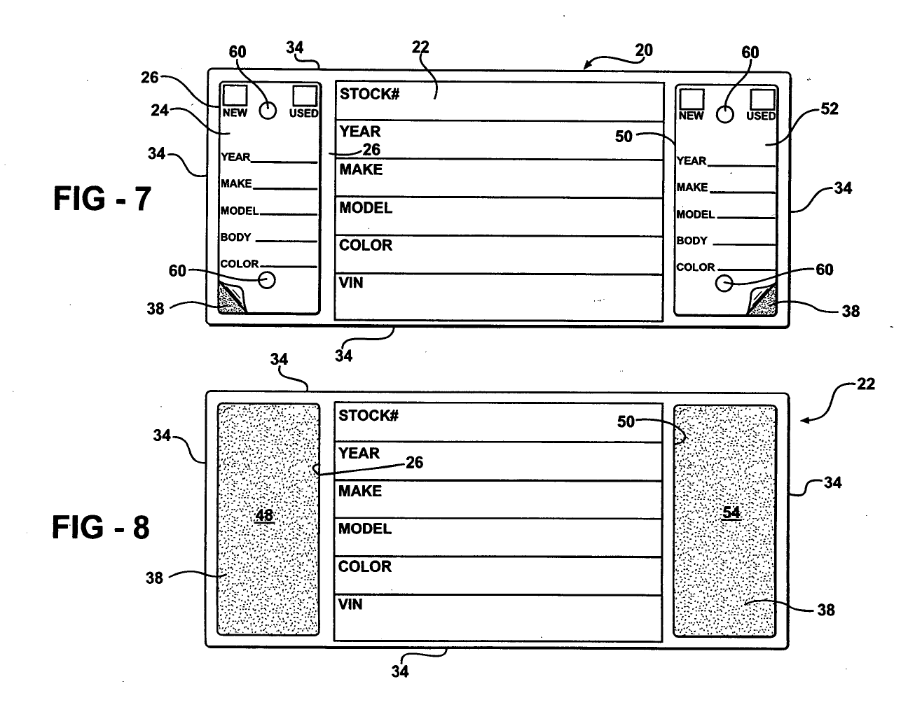

As shown in FIGS. 7-9, an alternative embodiment allows for additional flexibility such that the user can write the character and matching character on the card portion 22 and the tag portion 24 as required. The alternative embodiment also allows the card assembly 20 to be adapted to various application needs of identifying an article, such as keys or remote devices, to a vehicle. Also, this embodiment could aid in identifying inventory which is typically needed for a dealership or used car sales. In the alternative embodiment, the card portion 22 and tag portion 24 include preprint character fields with blank areas for writing the identifying information about the vehicle on both the tag portion 24 and card portion 22 of the assembly, i.e., year, make, model, body, color, stock and vehicle identification numbers.

Referring back to FIGS. 1-6, the card assembly 20 is design to be symmetrical with the tag portion 24 and the second tag portion 52 on opposing sides of the character 56 of the card portion 22. It should be appreciated that the placement of the tag portions 24 could be on the top, bottom, left or right of the character 56. However, as seen in the Figures, the preferred embodiments include the tag portion 24 and second tag portion 52 on the left and right side of the card assembly 20 with the character 56 placed between the tag portions 24. Therefore, when the tag portions 24 are removed the attachment areas 48 are on opposing sides of the card portion 22 for easily adhering the card portion 22 to the vehicle, i.e. the interior of a window. The tag portions 24 further define a hole 60 for easy attachment to an article such as a key set.

The subject invention includes a method for making the card assembly 20. The method comprises the steps of applying the first adhesive 36 to the first surface 30 of the liner 28 and disposing the first layer 40 on the first adhesive 36. A second adhesive 38 is applied to the second surface 32 of the liner 28 and disposing the second layer 42 on the second adhesive 38. The matching characters 58 are placed on the card portion 22 and the tag portions 24, and a peripheral edge 34 is cut through the first layer 40, the liner 28 and the second layer 42. The method further includes the extending of the scoreline 26 through the first layer 40, the first adhesive 36, and the liner 28 defining the tag portion 24. Additionally, a second scoreline 50 defines a second tag portion 52.

The subject invention further includes a method for using the card assembly 20 for matching a vehicle to an article, such as a key set. The user can remove one or both of the tag portions 24 to expose a portion of the second adhesive 38. The user can then attach the tag portion 24 to an article, such as the key set. If it is desired the user can add additional information on the tag portions 24 by writing such information on the tag portion 24 using a pen. The removed tag portions 24 expose a portion of the second adhesive 38 on the card portion 22 and allow for the card portion 22 to be adhere to the vehicle by adhering the exposed second adhesive 38 on a vehicle surface. The card portion 22 may have additional blank areas for the addition of vehicle information for identifying the tag portion 24 to the card portion 22 on the vehicle or for inventory purposes.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

1. A card assembly (20) for matching a vehicle to a key set comprising;
a liner (28) having a first surface (30) and a second surface (32) each extending to a peripheral edge (34),
a first adhesive (36) disposed on said first surface (30) of said liner (28),
a first layer (40) adhered to said first surface (30) of said liner (28) by said first adhesive (36),
a second adhesive (38) disposed on said second surface (32) of said liner (28),
a second layer (42) adhered to said second surface (32) of said liner (28) by said second adhesive (38),
a card portion (22) having a character (56) thereon and a tag portion (24) having a matching character (58) for matching said card portion (22) to said tag portion (24),
said card assembly (20) characterized by a scoreline (26) extending through a portion of said first layer (40), said first adhesive (36), and said liner (28) to define said tag portion (24) whereby said first layer (40) and said liner (28) of said tag portion (24) may be removed in unison from said second adhesive (38) to expose a portion of said second adhesive (38) and define an attachment area (48) of said card portion (22) wherein said tag portion (24) may be attached to the key set and said card portion (22) may be adhered to the vehicle:

2. An assembly as set forth in claim 1 wherein said card portion (22) extends to said peripheral edge (34).

3. An assembly as set forth in claim 2 further including a second scoreline (50) extending through a portion of said first layer (40), said first adhesive (36), and said liner (28) to define a second tag portion (52).

4. An assembly as set forth in claim 3 wherein said first layer (40), said first adhesive (36), and said liner (28) of said second tag portion (52) may be removed from said second adhesive (38) to expose a second portion of said second adhesive (38) and define a second attachment area (54) of said card portion (22).

5. An assembly as set forth in claim 4 wherein said scorelines are completely disposed within said peripheral edge (34) such that said attachment areas (48) are disposed within said peripheral edge (34).

6. An assembly as set forth in claim 5 wherein said tag portions (24) are completely disposed within said peripheral edge (34) of said card portion (22).

7. An assembly as set forth in claim 6 wherein said second tag portion (52) includes said matching character (58).

8. An assembly as set forth in claim 7 wherein said tag portion (24) and said second tag portion (52) are on opposing sides of said character (56) of said card portion (22).

9. An assembly as set forth in claim 8 wherein said tag portion (24) is on a left of said character (56) of said card portion (22) and said second tag portion (52) is on a right of said character (56) of said card portion (22) as viewed from a front of said card portion (22).

10. An assembly as set forth in claim 1 wherein said tag portion (24) and said second tag portion (52) each define a hole (60) for attachment to the key set.

11. An assembly as set forth in claim 7 wherein said character (56) and said matching character (58) are a numeral sequence.

12. An assembly as set forth in claim 1 wherein said first layer (40) and said second layer (42) are formed of a card stock material.

13. An assembly as set forth in claim 1 wherein said first layer (40) and said second layer (42) are formed of a plastic material.

14. An assembly as set forth in claim 1 further including a top laminate (44) that is transparent and disposed on said first layer (40).

15. An assembly as set forth in claim 1 further including a bottom laminate (46) that is transparent and disposed on said second layer (42).

16. A method of matching a vehicle to a key set using a card assembly (20) comprising a first adhesive (36) disposed between a liner (28), a first layer (40), and a second adhesive (38) disposed between a second layer (42) and the liner (28) and a scoreline (26) defining a tag portion (24) and a card portion (22) with matching characters (58) on the card portion (22) and the tag portion (24), said method comprising the steps of;
removing the tag portion (24) to expose a portion of the second adhesive (38),
attaching the tag portion (24) to the key set, and
adhering the exposed second adhesive (38) to the vehicle.

17. A method as set forth in claim 16 further including a second scoreline (50) defining a second tag portion (52) and further including the step of removing the second tag portion (52) to expose a second portion of the second adhesive (38).

18. A method as set forth in claim 17 wherein the step of adhering the adhesive (38) to the vehicle is further defined as adhering all exposed portions of the second adhesive (38) to the vehicle.

19. A method of making a card assembly (20) and matching a vehicle to a key set using the card assembly (20) said method comprising the steps of;
applying a first adhesive (36) to a first surface (30) of a liner (28),
disposing a first layer (40) on the first adhesive (36),
applying a second adhesive (38) to a second surface (32) of the liner (28),
disposing a second layer (42) on the second adhesive (38),
placing matching characters (58) on a card portion (22) and a tag portion (24),
cutting a peripheral edge (34) through the first layer (40), the liner (28), and the second layer (42),
extending a scoreline (26) through the first layer (40), the first adhesive (36) and the liner (28) defining the tag portion (24),
removing the tag portion (24) to expose a portion of the second adhesive (38),
attaching the tag portion (24) to the key set, and
adhering the exposed second adhesive (38) to the vehicle.
